(19) United States
(12) Patent Application Publication
(10) Pub. No.: US 2004/0011866 A1
(43) Pub. Date: Jan. 22, 2004

(54) Method and system for selling and delivering consumer products

(76) Inventor: Samir Saad, Bogota (CO)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/620,103

(22) Filed: Jul. 15, 2003

Related U.S. Application Data
(60) Provisional application No. 60/396,519, filed on Jul. 17, 2002.

(51) Int. Cl. G06K 5/00

(52) U.S. Cl. 235/380

(57) ABSTRACT

A method of selling and delivering a product includes distributing a product card, which includes product and card information, storing the product and card information in a computer system, collecting revenue from a purchaser of the card, and activating the card when the card is purchased so that the card can be redeemed. The product and card information and delivery information are received from the redeemer of the card and input into the computer system. Thereafter, the product associated with the product information is delivered to a location associated with the delivery information.

This application claims priority from co-pending U.S. provisional application Ser. No. 60/396,519, filed Jul. 17, 2002, which is incorporated by reference herein in its entirety.

### TECHNICAL FIELD AND BACKGROUND OF THE INVENTION

The present invention relates to the sale and delivery of consumer products using a prepaid product card, which is particularly suitable for the sale and delivery of gifts, such as flowers or floral arrangements. Although reference is made to the sale and delivery of flowers and floral arrangements, it should be understood that the method and system of the present invention may be used for selling and delivering other consumer products, including for example food, toys, clothes, accessories, or the like.

The distribution of flowers or floral arrangements has been heretofore been limited to a few channels, such as flower shops. Though flowers and floral arrangements are available in supermarkets and flower markets, these flowers and floral arrangements are typically available for direct sales to the retail customer without delivery options. In addition, the availability of flowers or floral arrangements in these venues are often limited by the retailers ability to refrigerate the flowers or floral arrangements and, further, by the retailers lack of knowledge of flower care and handling of the flowers in the store. Furthermore, supermarkets or flower markets may not typically have the processing room for hydrating and cleaning the flowers, which is often necessary to assure the freshness of the flowers. Therefore, new flower market channels have been difficult to open.

More recently, the Internet has provided a means for ordering a variety of consumer products, including flowers, and for establishing a delivery of the products from a distribution center via a courier, such as Federal Express or UPS. The Internet has improved the availability and accessibility from the purchaser's point of view. However, it has been found that the increase in availability and accessibility has not been met with a commensurate increase in demand maybe for at least the reason that these Internet stores have not reached the average consumer who still prefers to shop at retail locations.

Consequently, there is a need for a method and system that provides easier access to purchasers who wish to purchase consumer products, especially with delivery service of the consumer products.

### SUMMARY OF THE INVENTION

According to one form of the invention, a method of selling and delivering a product includes distributing a product card, which includes product and card information, such as a product identification code and a card identification code, storing the product and card information in a computer system, collecting revenue from a purchaser of the card, and activating the card when the card is purchased so that the card can be redeemed. The method further includes receiving the product and card information and the delivery information from the redeemer of the card, inputting the delivery information into the computer system, and delivering a product associated with the product and card information to a location associated with the delivery information.

In one aspect, the product and card information comprises a product identification code and a card identification code.

In other aspects, the activating includes storing an active status code in the computer system with the product and card information. In addition, the activation status code is determined based on the product and card information. If the card is activated, then the delivery information is input into the computer system.

In another aspect, the method further includes determining whether the product and card information is stored in the computer system to determine whether the card is valid.

In other aspects, the product card is provided with a description of the product associated with the product and card information. For example, the product card may include an illustration of the product.

In further aspects, the product card is encoded with a card identification code and a product identification code, which are associated with the product and card information. Optionally, the card may be additionally encoded with a retail store code associated with a retail location where the product card is distributed.

According to yet other aspects, the product card is encoded with a dollar amount associated with the product card. For example, the product card may the dollar amount associated with the retail store code.

In preferred aspects, the product card is displayed at a display location in the retail location. Because the card is not activated until purchased, the display location maybe essentially anywhere in the retail location and may be remote from a cashier of the retail location.

According to another from of the invention, a method of selling and delivering a product includes displaying a product card in a retail establishment, which is encoded with a product identification code and a card identification code and includes an illustration of the product associated with the product identification code, storing the product identification code and the card identification code in a computer system, collecting revenue from a purchaser of the card, receiving the product identification code, the card identification code, and the delivery information from the redeemer of the card, inputting the delivery information into the computer system, and delivering a product associated with the product identification code to a location associated with the delivery information.

In one aspect the card is activated either (a) when the card is received by a retailer or (b) when the card is purchased, so that the card can be redeemed. For example, an activation status code may be stored in the computer system along with the card identification code. Before inputting the delivery information, the activation status of the card is confirmed to be active. In addition, the validity of the card is checked by confirming whether the card identification code is stored in the computer system.

In preferred form, the product card includes ordering information. For example, the product card may include an Internet address to a web site where the card can be redeemed online.

In other aspects, revenue is collected from the retail establishment for distributing the product cards based on at least a percentage of a dollar amount associated with the product card. In addition, a portion of the revenue is applied toward delivery costs of the product associated with the product identification code.

According to yet other aspects, a contact is provided who can receive the product identification code, the card identification code, and the delivery information from the redeemer of the card and input the delivery information in to the computer system.

According to another form of the invention, a sales and delivery system for delivering consumer products includes a product card, which is associated with a product, a computer system, which has data information about the card, such card identification information and product identification information about the product associated with the card, and an order fulfillment center for delivering an order to either the intended recipient of the order or a mailing service. The order fulfillment center is communication with the computer system from which it receives orders. The system also includes a card processor, which is in communication with the computer system, which stores an active status code for the card when the card is read by the card processor, which preferably occurs when or after the card is purchased. The system also provides a link to the computer system, which is accessible to a redeemer of the card and permits the redeemer of the card to redeem the card. The computer system receives delivery information from the redeemer through the link and generates an order for the product and forwards the order to the order fulfillment center provided that the card has been activated, where the order is then filled and delivered.

In one aspect, the link comprises a telephone link. In addition, the telephone link is preferably manned by an operator, who receives the data information and the delivery information from the redeemer and inputs the delivery information into the computer system. Alternately, the link may comprise an Internet link.

In yet other aspects, the sales and delivery system further includes a website, with the computer system downloading at least some of the data information to the website. Preferably, the order fulfillment center is in communication with the website. Optionally, the Website is accessible by the redeemer. The website includes the card identification and product identification information and the delivery information and may optionally include tracking information. In this manner, the redeemer may track the status of their order.

Other features, objects, or advantages of the present invention will become more apparent from a study of the detailed description taken in conjunction with a review of the accompanying drawings.

### DETAILED DESCRIPTION OF THE DRAWINGS

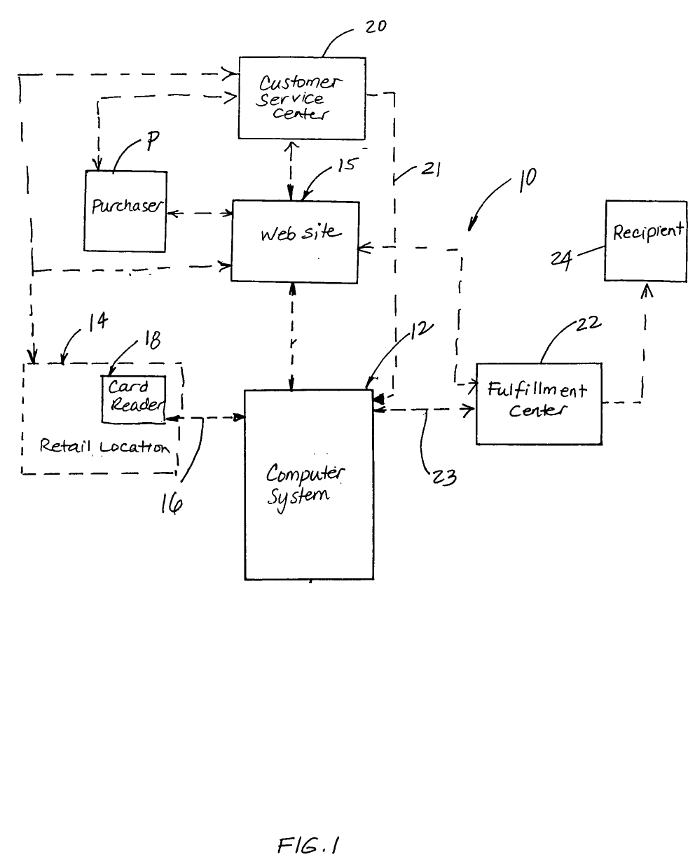

FIG. 1 is a schematic drawing of the system for selling and distributing prepaid delivery services for consumer products of the present invention;

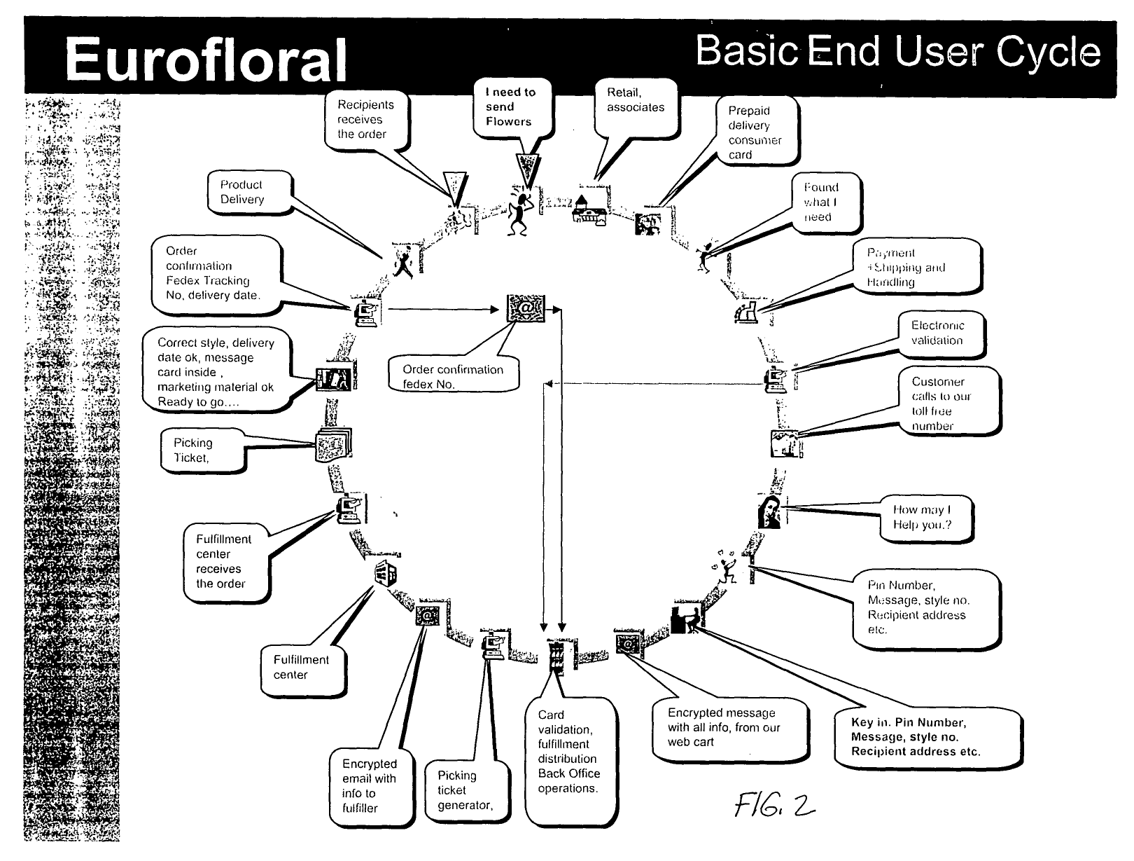

FIG. 2 is a flow chart of the purchase and delivery cycles of the method and system of selling and delivering flowers or floral arrangements using a prepaid card of the present invention;

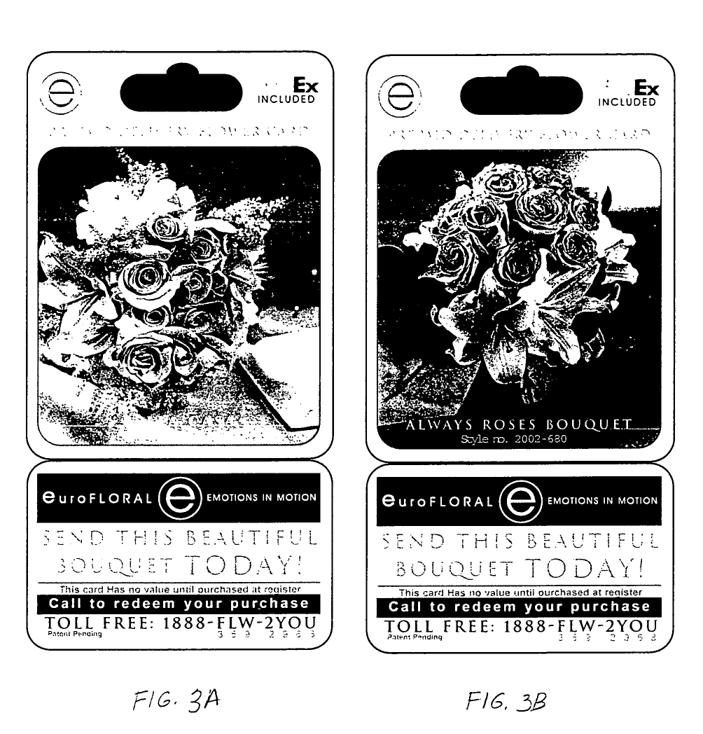

FIGS. 3A and 3B are illustrations of a prepaid card and its merchandising presentation of the method and system of the present invention; and

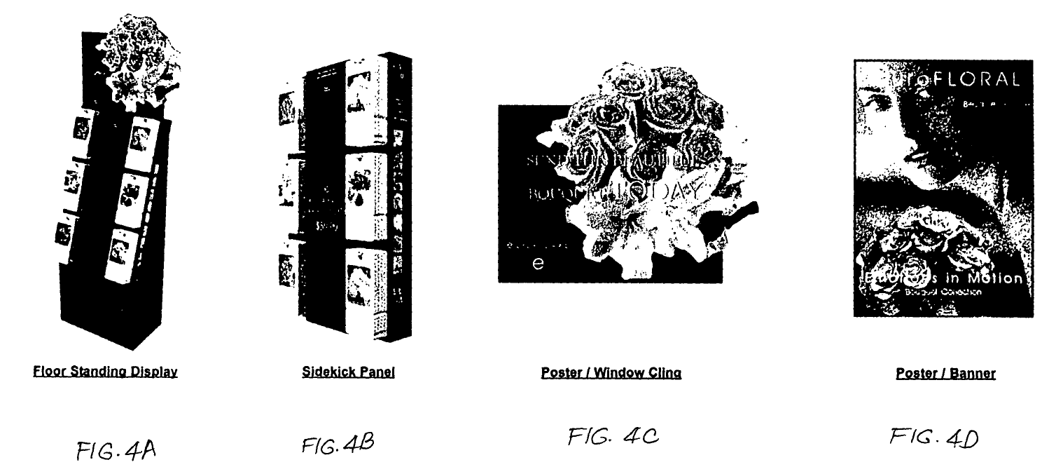

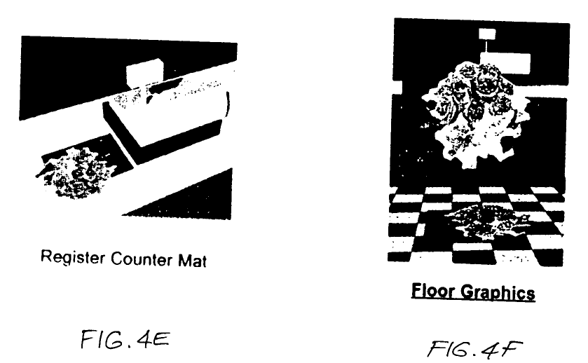

FIGS. 4A-4F illustrate various merchandizing displays that can be used with the method and system of the present invention.

### DETAILED DESCRIPTION OF THE PREFERRED EMBODIMENTS

The present invention provides a method and system of selling and distributing a consumer product, such as delivered flowers or floral arrangements, in which a customer may purchase a prepaid coupon or card for the product. The price of the card covers the purchase price of the product, as well as the delivery price for the product. Furthermore, the card has associated therewith an optional illustration of the product to be purchased, as well as ordering information, so that a customer will be able to redeem its purchase from the comfort of their home, office, car, or the like using a phone, including a cellular phone, or the Internet. It can be appreciated that the customer may redeem the card practically anywhere—and, further, can give the card to someone else to redeem.

Initially, the prepaid cards are distributed to retailers by a wholesaler. The wholesaler collects payment from the retailer, which payment represents at least a percent of the dollar amounts associated with the cards. Each card preferably includes a UPC code for tracking purposes for the retailer. In addition, referring to FIG. 3A, each card or packaging will include method of delivery information, including, for example, how the products are to be shipped (and may provide any additional fees that are associated with the shipment of the perishable products, such as flowers or floral arrangements).

In addition, the cards also include order instructions, for example by providing a telephone number or website address so that the purchaser of the card can redeem the purchase either via telephone or by the Internet. The card optionally includes an expiration date after which the card is no longer redeemable and becomes void. Other information provided on the card may include a retail store code so that the volume of sales and the origin of the sales for a particular store or retail establishment may be tracked in the system. In addition, the card includes product and card identification information, such a product identification code associated with the product described or illustrated on the card and a card identification code that is used to validate the card. The information is preferably provided in electronically readable form and may be hidden by a scratch-off surface or removable cover, such as a flap, or the like. The dollar amount may be directly encoded in the card identification code, which may vary by product and/or by retail location. For example, cards sold at large discount sellers may have lower dollar amounts on the cards than cards sold at upscale grocery stores. In addition, the dollar amount may be independent of the retail establishment so that customers at a retail store may have a choice of cards with different dollar amounts.

On the front face of the card, the card may include an illustration of the product as well as a type or name of the product. For example, for flowers, a photo of an exemplary bouquet may be provided. This illustration may be provided on the packaging in addition to or instead of on the card. The card may also include an indication of the type of motivation a purchaser would have to buy the product, for example, a “happy birthday” bouquet, “I am sorry” bouquet, a “congratulations” bouquet, etc. The front face of the card or also includes an indication of the price of the product, which price includes the shipping and handling of the product. As noted above, the front face of the card may include an illustration of the particular product being ordered. The rear face of the card may include an alternate choice in the event that the choice illustrated on the front of the card is not available for delivery within a prescribed time. For example, the prescribed time may be 24 hours, or more.

After the cards are delivered to a retailer, the retailer confirms receipt of the cards, which may activate the cards or merely change the status of the card, as will be more fully described below. In this manner, while the cards are in transit, the cards are invalid and inactive and cannot be used. Alternatively, and more preferably, the cards are validated upon receipt of the cards by the retailer and activated upon the sale of the card or at a later time by the retail customer. In this manner, the card can not be used without being paid for first; thus, reducing or eliminating the chances of the card being shoplifted. This added measure of security is particularly attractive to retail shops and stores who collectively loose millions of dollars each year due to shoplifting. Moreover, this enables the retail establishment to locate the card displays anywhere in the retail location because there is no risk of loss for the retail merchant. If the card is lost or stolen, the retail can deactivate the card by contacting the customer service center noted below.

Referring to FIG. 1, the numeral 10 generally designates the system for selling and delivering consumer products of the present invention. System 10 includes a computer system 12 that stores, communicates, and receives and processes the various information related to the sale, tracking, distribution, accounting, and inventory of the products. Computer system 12 may comprise a single computer or a plurality of computers, which would be in communication with at least one central computer or in communication with each other, such as by a network. In which case, the database could be stored on the network or server. For example, computer system 12 may be programmed to store information or data relating to the sale of the products, for example, to track the product sales at a specific location, the volume of sales for any given product, or the like. This data can be used to adjust inventory, pricing, product ordering, or the like. This data is collected and stored in a database that is loaded onto a website 15 for access by the retailer, the customer, a customer service center 20, and a fulfillment center 22, which will be more fully described below.

After the cards are delivered to a retail location or establishment, the retailer acknowledges or confirms receipt of the cards. After this confirmation, the card and product information, such as card and product identification codes, are entered into database 15 so that the computer system 12 will recognize the card and product information, which can be in the form or codes as noted above, including numbers and/or letters or other indicia, such as a holographic picture, as representing valid cards.

To track the sale of a card, computer system 12 is in communication with each retail location 14, for example, through a link 16. Each retail location 14 preferably includes a card processor 18, such as a card reader unit, which communicates with computer system 12 via link 16, such as a telephone system or a wireless communication line or the like, and downloads the card and product information onto the database or website 15, which in turn will be uploaded to computer system 12. In addition, as noted, computer system 12 is in communication with one or more customer service centers 20 through a link 21, such as a telephone system or a wireless communication link or the like, and one or more order fulfillment centers 22 through a link 23, such as a telephone system or a wireless communication link or the like. Though illustrated and described as discrete centers, the customer service centers and fulfillment centers maybe located at a single center that provides both functions. Furthermore, the customer service centers 20 and fulfillment centers 22 may or may not be remote from computer system 12. Customer service centers 20 provide a contact through which a card can be redeemed, while the fulfillment centers fill and package the orders, as will be more fully described below, and forward the orders on to a third party delivery service. Alternately, fulfillment centers may directly deliver the products to the recipient.

As noted previously, computer system 12 receives communication from the card processors (18) located at each of the retail locations (14). When a customer selects a card for purchase and purchases a card, the retail operator or clerk will then read the card with the card processor (18). Card processor 18 in turn will transmit a signal to computer system 12 that conveys the card identification code and other optional identifying information about that particular card and/or about the retailer, which is either magnetically coded or bar coded onto the card, so that computer system 12 stores in its database that that particular card has been activated so that it can be used. As a result, a card has no value and cannot be redeemed until it is purchased.

When a purchaser enters a retail establishment that carries the prepaid cards, the purchaser will preferably be greeted with a card display and preferably some advertising displays. The card display may comprise a floor standing display or a sidekick display panel. Suitable advertising displays include a poster, a floor mat display, or a counter mate display or the like. The floor standing displays and sidekick panel display display the cards in a compact arrangement and, preferably, in groups that organize the products, for example, by collections or target recipients, or the like. For example, where the products are flowers or floral arrangements, the products may be arranged by occasions or by sentiments. When the cards are activated upon purchase, it can be understood that the card displays can be located anywhere in the retail location with any risk of loss because they have no value until activated.

The cards are displayed preferably by product so that a purchaser may select the particular type of product, such as a floral arrangement, they wish to purchase. For example, referring to FIGS. 4A and 4B, the cards are preferably displayed and mounted to the standing display or display panel by packaging, such as blister packaging, hang tags, or other customary methods used in the retail trade, so that at least the front face of the card is visible to the retail customer. Optionally, the packaging may permit both sides of the card to be visible so that the retail customer can view the information on the backside of the card. In the preferred embodiment, the card and/or packaging includes contact information, such as the website where the products can be ordered, and product identification information, such as the name of the collection of the products, a product code, a card identification code, which identifies the card, which is preferably hidden from view, such as by scratch-off surface, or a removable cover, or the like. The packaging or card may include an indication of a private label, such as Banana Republic or Bed, Bath & Beyond or the like. Furthermore, the card or packaging may include information about a reward program or about a donation program.

Once the card is purchased and, then, activated, the purchaser or the recipient of the card may then place an order. To place an order for the product, purchaser P contacts an order-processing center 20 by telephone or may order on line through web site 15. Preferably, the order processing centers are manned by operators to whom the purchaser provides the card identification code associated with the card. In addition, the purchaser provides the operator with the delivery information, such as the recipient's name, address, or other contact information, including a contact phone number or email number, and, further, the message they wish to be written on the note card that accompanies the gift. Optionally, the card may include a separate product identification code and/or a product name, which can also be provided to the operator with the product code, which is preferably illustrated, such as by a photograph, on the card or packaging.

Once the operator receives the information, the operator inputs the information into a database stored in computer system 12 so that the delivery process may begin. In addition to the delivery information, the operator inputs the order date, the order location and may also input customer information, such as the customer's name, phone number, email address, and/or home address. The operator may also input billing information. The database includes the card identification codes for all the cards that have been distributed to retailers. Therefore, before the operator initiates the input of the order data, the operator checks to see if the card identification number represents a valid card. In addition, the database includes the activation status of the cards, as noted above, which is also checked by the operator. Should the card be invalid or inactive no order will be processed.

Included in the database are dollar amount values for the cards, as well as information about the product associated with the card. After the operator or computer system 12 determines that the card number is valid and the card is activated, computer system 12 generates and sends a message, such as an email, to a fulfillment center or warehouse 22, which includes all the necessary information to fulfill the order. For example, computer system 12 may generate a picking ticket, which includes the necessary information to fill the order and, further, may encrypt the order. Once fulfillment center 22 receives the order, for example, via email, fulfillment center 22 prints or generates the picking ticket and the message card. The order is then completed—the selected product is matched up with the order along with the message card and any care and/or handling instructions. In the case of flowers, a packet of flower food may be added to the order. Once assembled, the items are then packaged, for example in a box, and mailed. Preferably, the orders are sent by an express mail service.

After the order is filled and forwarded to the mail service, fulfillment center 22 generates an order confirmation that is sent to computer system 12 and input into the database. In addition to the recipient's name, the order confirmation may include tracking information, including the expected date of delivery and the tracking number provided by the mail service. Once computer system 12 receives the order confirmation, the database is then updated to reflect the new status of the order and, further, notification is sent to the customer by email, which preferably includes the tracking information so that the customer or redeemer of the card can personally track the delivery of the product, for example, through the Internet.

Once system 12 receives the confirmation of the delivery of the order, for example, from the mail service, computer system 12 changes the status of the order to “filled”. In addition, optionally once confirmed, computer system 12 generates and sends the purchaser a message, such as an email, confirming the delivery.

To facilitate selection of products, the cards or packaging preferably include illustrations of the product. Further as noted above, the cards may be grouped, for example, by holiday, by sentiments, such as “I love you,” “I am sorry,” “Sympathy,” “Happy Birthday,” “Happy Anniversary,” “Happy Valentines Day,” “Happy Mothers Day,” “Merry Christmas,” or the like. These sentiments are also preferably expressed on the prepaid flower card so that when the retail customer purchases a card, the customer will be selecting the type of flower or floral arrangement or the sentiment the customer wishes to express. In addition, for flowers or floral arrangements the card may, for example, include a photograph of an exemplary bouquet of the type selected in the collection and also substitute arrangements that may be made by the fulfillment center.

Optionally, the system of the present invention may incorporate a promotional program, which may include, for example a percent of sales being given to customers in the form of direct marketing campaigns, P.O.S. and collateral material, such as GWP (gift with purchase), PWP (purchase with purchase). The advertising may include magazine advertisements, newspaper advertisements, Internet advertisements, television commercials, or the like.

As previously noted, the method and system of the present invention utilizes a customer service center, which is manned by operators who receive the incoming orders and input the incoming orders and delivery information to computer system 12, which forwards the orders to a fulfillment center. Preferably, when an order is received (whether by email via an Internet redemption or by telephone), the operator inputs the tracking information, the product information, and the delivery information (including the contact information) into the system database, which is stored in computer system 12 and further downloaded to web site 15. Alternately, the computer system 12 may check the card identification code to see if the card is valid and/or activated. This check may be performed by a comparison database listing of valid card numbers. Preferably, the customer service center is contacted using a 1-800 number provided on the back of the card, where bilingual operators are available to receive incoming orders. The operators place the incoming orders on the computer system in real time sending the order confirmation via email to the retail customer and the order placement email or ticket to the centralized delivery warehouse or fulfillment center.

In addition, the customer service center preferably includes a customer help desk, which is also preferably manned by people who can provide direct, personal service to a customer. Preferably, the help desk can also communicating with computer system 12 and has access to the website, so that each inquiry can be tracked to resolve the problem, which may include providing a new delivery or a full refund. For example, when an inquiry is received, the customer help desk creates a “case data” entry in the database. The case data includes tracking data, customer data, and information relating to the problem. This case data will remain in the database until the problem has been resolved—though it should be understood that computer system 12 may store archive files or keep a record of the case data for future reference.

As noted above, the method and system of the present invention incorporates a website 15, which provides information and support to end user customers, retail associates, and operators, and other distribution channels. Operators and retail associates are provided with a password to access information, such as visual merchandising documents, collection catalogs, associate books, card specials, delivery dates, and hours. Customers, who are also given a password, can access at least some of the data related to their order. For example, customers may access the data relating to the status, delivery date, and mail service's tracking information. Therefore, the website acts as a repository for the database so that at least some of the information is readily available to a variety of different people. As noted before, the information or data relating to orders as well as inventory information for the products distributed to retailers is stored on the computer system, which permits access or exchange of the data or information and which can be used for accounting, invoicing or other functions. Alternately, the website may be used a medium to contact computer system, for example by email messages, rather than acting as a repository. In this manner, the computer system would be the central and only repository.

In addition, the computer system may be used to track the profiles of the customers of the system to develop target markets and, further, to develop price points for the products.

It can be appreciated from the foregoing that the method and system of the present invention provides access to old and new markets and, further, allows different businesses without any knowledge of an industry, such as the flower industry, to participate actively in the business. The present invention relates to a method and system of selling and distributing consumer products using a prepaid card. As previously noted, the prepaid card includes ordering information, such as a contact address, including a telephone number and/or website address. The card also includes one or more codes that can identify parameters, such as the origin of the purchase. Optionally and preferably, the card provides at least a general description of the consumer product being purchased and associated with the product code and more preferably an illustration of the product. For example, the card may include a photo and/or with a description of the type of product, such as the sentiment associated with the product, e.g. a thank you bouquet, a jolly holiday bouquet, business magic bouquet, congratulations bouquet, happy birthday bouquet, or the like. Optionally, the card may include a description of the bouquet, listing, for example, the flowers in the bouquet and how the flowers are presented, e.g. tied with a ribbon or raffia.

Furthermore, given the design and presentation of the prepaid flower card, the card may be displayed in retail stores, using mass marketing display fixtures. It is preferable that the cards are displayed in a display fixture designed specifically for displaying the cards, with optional visual aids for promoting the prepaid delivery card service. Furthermore, as previously described, the card may be redeemed by way of a telephone call or through the Internet by logging onto the website. Furthermore, as will be appreciated from the description of the foregoing method and system, the present system allows for distribution of the profit among the participants in the sale and delivery process. In this manner, the profits may be distributed more evenly than heretofore and may be distributed according to relative risk bourne by the participants or according to terms agreed on by the various participants. As a result, the present invention provides a method and system that will enable retailers to concentrate or focus on what they do best—selling. The system enables a retailer to drastically increase the number of products displayed in a given floor space because the products are represented on the cards, which occupy very little space as compared to the products themselves. Furthermore, the receiving, merchandizing, including visual merchandizing, design of the products, for example of the floral arrangements, point-of-sale (POS) material, order processing, order delivery, customer service issues, security, product quality control, product stocking or invention, and advertising can all be done by a centralized system that is located outside and is separate from he retail establishment.

Another benefit provided by the present system is that a purchaser can see what is actually being delivered. For example, with most current floral delivery systems, the purchaser may not see what arrangement is being delivered or may not see the arrangement that is substituted for the arrangement that they have selected. In contrast, not only does the present system allow the purchaser to view the selected product but also the alternate products that can be substituted in the event that the selected product cannot be delivered.

I claim:

1. A method of selling and delivering a product, said method comprising:
distributing a product card including product and card information;
storing the product and card information in a computer system;
collecting revenue from a purchaser of the card;
activating the card when the card is purchased so that the card can be redeemed;
receiving the product and card information and delivery information from the redeemer of the card;
inputting the delivery information into the computer system; and
delivering a product associated with the product information to a location associated with the delivery information.

2. The method according to claim 1, wherein said distributing a product card includes distributing a product card with product and card information comprising a product identification code and a card identification code, and said storing includes storing the product identification code and the card identification code in the computer system.

3. The method according to claim 1, wherein said activating includes storing an active status code in said computer system with the card identification code.

4. The method according to claim 2, further comprising:
determining the activation status code of the card based on the product and card information; and
if the card is activated then inputting the delivery information into the computer system.

5. The method according to claim 1, wherein said determining further includes determining whether the product and card information is stored in said computer system to determine whether the card is valid.

6. The method according to claim 1, further comprising:
providing the product card with a description of the product associated with said product and card information.

7. The method according to claim 6, wherein said providing the product card with a description of the product includes providing the card with an illustration of the product.

8. The method for doing business according to claim 1, wherein said providing a product card includes encoding the card with a card identification code and the product identification code associated with said product and card information.

9. The method according to claim 8, said encoding includes encoding the card with a retail store code associated with a retail location where the product card is distributed.

10. The method according to claim 1, wherein said providing a product card includes providing a product card encoded with a dollar amount associated with the product card.

11. The method according to claim 10, wherein said providing a product card includes providing a product card with encoded with a retail store code, said dollar amount associated with said retail store code.

12. The method according to claim 1, further comprising displaying said product card at a display location in the retail location.

13. The method according to claim 12, further comprising locating the display location remote from a cashier of the retail location.

14. A method of selling and delivering a product, said method comprising:
displaying a product card in a retail establishment, the product card encoded with a product identification code and a card identification code and including an illustration of the product associated with the product identification code;
storing the product identification code and the card identification code in a computer system;
collecting revenue from a purchaser of the card;
receiving the product identification code, the card identification code, and the delivery information from the redeemer of the card;
inputting the delivery information into the computer system; and
delivering a product associated with the product identification code to a location associated with the delivery information.

15. The method according to claim 14, further comprising:
activating the card either (a) when said card is received by a retailer or (b) when the card is purchased, the card being activated so that the card can be redeemed.

16. The method according to claim 15, wherein said activating includes storing an active status code in said computer system with the card identification code, and said inputting includes confirming that the computer system indicates an active status code for said product car before inputting said delivery information.

17. The method according to claim 14, wherein said inputting includes confirming includes determining whether the card identification code is stored in said computer system to determine whether the card is valid.

18. The method according to claim 14, wherein said providing a product card includes encoding the card with the card identification code and the product identification code.

19. The method according to claim 14, wherein said displaying includes displaying the product card at a display location in the retail establishment, and locating the display location remote from a cashier of the retail establishment.

20. The method according to claim 14, wherein said providing a product card includes providing a product card with ordering information.

21. The method according to claim 20, wherein said providing a product card with ordering information includes providing a product card with an Internet address to a web site where the card can be redeemed online.

22. The method according to claim 14, further comprising collecting revenue from the retail establishment for distributing the product cards based on at least a percentage of a dollar amount associated with the product card.

23. The method according to claim 22, further comprising applying a portion of the revenue toward delivery costs of the product associated with said product identification code.

24. The method according to claim 14, further comprising providing a contact for the purchaser, the contact receiving the product identification code, said card identification code, and the delivery information and inputting the delivery information into the computer system.

25. A sales and delivery system for delivering consumer products, said system comprising:
a product card, said product card associated with a product;
a computer system, said computer system having stored therein data information about said card, said data information including card identification information about said card and product identification information about said product associated with said card;
an order fulfillment center for delivering an order to one chosen from a recipient and a mailing service, said order fulfillment center being in communication with said computer system;
a card processor, said card being read by said card processor when said card is purchased, said card processor in communication with said computer system, and said computer system storing an active status code for said card when said card is read by said processor; and
a link to said computer system accessible to a redeemer of said card, said link permitting the redeemer of said card to redeem said card, said computer system receiving delivery information from the redeemer through said link and generating an order for said product and forwarding said order to said order fulfillment center provided that said card has been activated, and said order fulfillment center delivering the order.

26. The sales and delivery system according to claim 25, wherein said link comprises a telephone link.

27. The sales and delivery system according to claim 26, wherein said link further comprises an operator, said operator receiving said data information and said delivery information from the redeemer through said telephone link, said operator inputting said delivery information into said computer system.

28. The sales and delivery system according to claim 25, wherein said link comprises an Internet link.

29. The sales and delivery system according to claim 25, wherein said order fulfillment center delivers an order to a mailing service for delivery of said order to the recipient.

30. The sales and delivery system according to claim 25, wherein said card processor comprises a card reader.

31. The sales and delivery system according to claim 25, further comprising a website, said computer system downloading at least some of said data information to said website.

32. The sales and delivery system according to claim 31, wherein said order fulfillment center is in communication with said website.

33. The sales and delivery system according to claim 31, wherein said website is accessible by the redeemer.

34. The sales and delivery system according to claim 31, wherein said website includes said card identification and product identification information and said delivery information.

35. The sales and delivery system according to claim 34, wherein said website further includes tracking information.
